(19) United States
(12) Patent Application Publication
(10) Pub. No.: US 2005/0122652 A1
(43) Pub. Date: Jun. 9, 2005

(54) Apparatus for power supply systems

(76) Inventors: Michael Richardson, Sutton (GB); David Kelsall, Wigan (GB)

Correspondence Address: ADAMS EVANS P.A., 2180 TWO WACHOVIA CENTER, CHARLOTTE, NC, 28282, US

(21) Appl. No.: 10/493,300

(22) PCT Filed: Oct. 3, 2002
(86) PCT No.: PCT/GB02/04468

(30) Foreign Application Priority Data
Oct. 23, 2001 (GB) 01253707

(51) Int. Cl. H02H 3/24

(52) U.S. Cl. 361/92

(57) ABSTRACT

There is disclosed a control apparatus (12) for a power supply system (2) operable at a fluctuating line voltage, the system further comprising an energy storage device (10), and the control apparatus further comprising a line voltage monitor (14) and an energy storage device controller (12), wherein the control apparatus is configured whereby the energy storage device is at least partly discharged if the line voltage falls below a first predetermined voltage and the energy storage device is at least partly charged if the line voltage exceeds a second predetermined voltage and in which the first predetermined voltage is substantially lower than the second predetermined voltage. A power supply system (12) incorporating such a control apparatus is disclosed, as is a method of control thereof.

### FIELD OF THE INVENTION

The present invention relates to control apparatus for power supply systems, to power supply systems comprising such control apparatus and to methods of operating the same.

### BACKGROUND TO THE INVENTION

Many power supply systems have undesirable fluctuations in their respective line voltages. For instance, in a power supply to an underground (subway), or a power supply from a wind turbine there are undesirable fluctuations. Demand, in the first case, and supply, in the second, vary. Such line voltage variation can cause degraded performance and uncertainty for power suppliers.

It is an aim of preferred embodiments of the present invention to overcome or obviate a problem of the prior art, whether referred to herein or otherwise.

### SUMMARY OF THE INVENTION

According to the present invention in a first aspect, there is provided a control apparatus for a power supply system operable at a fluctuating line voltage, the system further comprising an energy storage device, and the control apparatus further comprising a line voltage monitor and an energy storage device controller, wherein the control apparatus is configured whereby the energy storage device is at least partly discharged if the line voltage falls below a first predetermined voltage and the energy storage device is at least partly charged if the line voltage exceeds a second predetermined voltage and in which the first predetermined voltage is substantially lower than the second predetermined voltage.

Suitably, in the voltage region between the first and second predetermined voltages, the energy storage device is driven to a predetermined charge setting between a maximum charge setting and a minimum charge setting.

Suitably, the first and second voltages are determined relative to a mean line voltage. Suitably, the mean line voltage is determined by a time average over a predefined rolling time interval.

Suitably, an idle charge is defined with a positive idlewindow above the idlecharge and a negative idlewindow below the idlecharge, whereby in a region between the first predetermined voltage and the second predetermined voltage the energy storage device is neither charging nor discharging as the charge decreases until the charges reaches the negative idlewindow when it charges to a charge between the positive idlewindow and the negative idlewindow, preferably the idlecharge, and then neither charges nor discharges until the negative idlewindow is reached. In the case of a flywheel energy storage device, it will be coasting in this region.

Suitably, a third voltage below the first predetermined voltage defines a reduced discharge region between the first predetermined voltage and the third voltage, in which the energy storage device is discharged at a lower rate than in a discharge region in which the line voltage is lower than the third voltage.

Suitably, a fourth voltage above the second predetermined voltage defines a reduced discharge region between the second predetermined voltage and the fourth voltage, in which the energy storage device is charged at a lower rate than in a charge region in which the line voltage is higher than the fourth voltage.

Suitably, an energy storage device maximum charge is defined and a maximum charge idlewindow is defined below and in relation thereto, and the apparatus is configured whereby if the line voltage is above the second predetermined voltage, upon the energy storage device reaching maximum charge it is neither charged nor discharged until the energy storage device charge falls to the maximum charge idlewindow at which stage the energy storage device is charged.

Suitably, an energy storage device minimum charge is defined and the apparatus is configured whereby upon the energy storage device reaching the energy storage device minimum charge the energy storage device is neither charged nor discharged until the line voltage rises above the first predetermined voltage.

Suitably, the energy storage device is a flywheel. In this case charge of the flywheel is represented by speed thereof.

According to the present invention in a second aspect, there is provided a power supply system comprising a control apparatus according to the first aspect of the invention.

Suitably, the power supply system is for a transport system, preferably a rail transport system.

According to the present invention in a third aspect, there is provided there is provided a method of controlling a power supply system operating at a fluctuating line voltage, the system further comprising an energy storage device, and the control apparatus further comprising a line voltage monitor and an energy storage device controller, whereby the energy storage device is at least partly discharged if the line voltage falls below a first predetermined voltage and the energy storage device is at least partly charged if the line voltage exceeds a second predetermined voltage and in which the first predetermined voltage is substantially lower than the second predetermined voltage.

Suitably, in the voltage region between the first and second predetermined voltages, the energy storage device is driven to a predetermined charge setting between a maximum charge setting and a minimum charge setting.

Suitably, the first and second predetermined voltages are determined relative to a mean line voltage. Suitably, the mean line voltage is determined by a time average over a predefined rolling time interval.

Suitably, an idlecharge is defined with a positive idlewindow above the idlecharge and a negative idlewindow below the idlecharge, whereby in a region between the first predetermined voltage and the second predetermined voltage the energy storage device is neither charging nor discharging as the charge decreases until the charge reaches the negative idlewindow when it charges to a charge between the positive idlewindow and the negative idlewindow, preferably the idlecharge, and then neither charges nor discharges until the negative idlewindow is reached. In the case of a flywheel energy storage device, it will be coasting in this region.

Suitably, a third voltage below the first predetermined voltage defines a reduced discharge region between the first predetermined voltage and the third voltage, in which the energy storage device is discharged at a lower rate than in a discharge region in which the line voltage is lower than the third voltage.

Suitably, a fourth voltage above the second predetermined voltage defines a reduced discharge region between the second voltage and the fourth voltage, in which the energy storage device is charged at a lower rate than in a charge region in which the line voltage is higher than the fourth voltage.

Suitably, an energy storage device maximum charge is defined and a maximum charge idlewindow is defined below and in relation thereto, and the apparatus is configured whereby if the line voltage is above the second predetermined voltage, upon the energy storage device reaching maximum charge it is neither charged nor discharged until the energy storage device charge falls to the maximum charge idlewindow at which stage the energy storage device is charged.

Suitably, an energy storage device minimum charge is defined and the apparatus is configured whereby upon the energy storage device reaching the energy storage device minimum charge the energy storage device is neither charged nor discharged until the line voltage rises above the first predetermined voltage.

Suitably, the energy storage device is a flywheel. In this case charge of the flywheel is represented by speed thereof.

### BRIEF DESCRIPTION OF THE DRAWINGS

The present invention will be described, by way of example only, with reference to the drawings that follow; in which:

FIG. 1 is a schematic illustration of a power supply system according to an embodiment of the present invention.

FIG. 2 is a control power profile illustrating operation of the present invention.

FIG. 3 is a graph illustrating line voltage in a discharge region.

FIG. 4 is a graph illustrating line voltage in a charging region.

FIG. 5 is a graph illustrating line voltage in a first recovery region.

FIG. 6 is a graph illustrating line voltage in a second recovery region.

FIG. 7 is a graph illustrating predicted flywheel performance.

### DESCRIPTION OF THE PREFERRED EMBODIMENTS

Referring to FIG. 1 of the drawings that follow, there is shown a power supply system 2 comprising a DC power supply 4 connected by a power supply line 6 to a plurality of power consumers 8A-8D. In the power supply line 6 is a flywheel energy storage device 10. Also in the system is a flywheel controller 12, which also serves the function of monitoring the flywheel speed (measured in cycles per second Hz) and a line voltage monitor 14.

The power supply 4 can be any power supply, such as a turbine (including wind turbine and micro turbine) or grid. The power consumers 8A-8D can be of any nature though the embodiment of the present invention is intended for power supply systems in which the line voltage fluctuates so generally the power consumers will be non-constant. Typical power consumers for which the present invention is applicable are tram, railway or underground (subway) units in which there is substantial load variation as they accelerate and decelerate.

The flywheel 10 in a preferred example of an energy storage device suitable for the present invention. A preferred flywheel 10 is a magnetic composite flywheel such as that described in WO97/13313, the content of which is incorporated herein by reference. There are magnetically loaded composite based rotors for energy storage. The charge of the flywheel is proportional to the square of its speed.

Flywheel controller 12 controls whether the flywheel is in one of seven modes: A) full discharge, B) reduced discharge, C) recovery discharge, D) coasting, E) recovery charge, F) reduced discharge and G) full charge dependent on the line voltage and current speed of the flywheel 10. In this embodiment flywheel controller 12 acts as control apparatus for the power supply system 2.

Flywheels 10 according to the preferred embodiments of the present invention have an operating speed range between a base speed of 500 Hz to a top speed of 600 Hz. When in discharge mode the flywheel can only drive down to the base speed when the associated electronics (eg flywheel controller 12) are disabled. When in charge mode, the flywheel drives up to the top speed before disabling the associated electronics.

The line voltage monitor 14 reads the line voltage every 0.5 millisecond, and includes a software filter with a preset time constant, typically 2.5 millisecond to stabilise the system and prevent it responding unnecessarily to rapid transients.

The control system is operated by a computer program operating on a computer system (not shown).

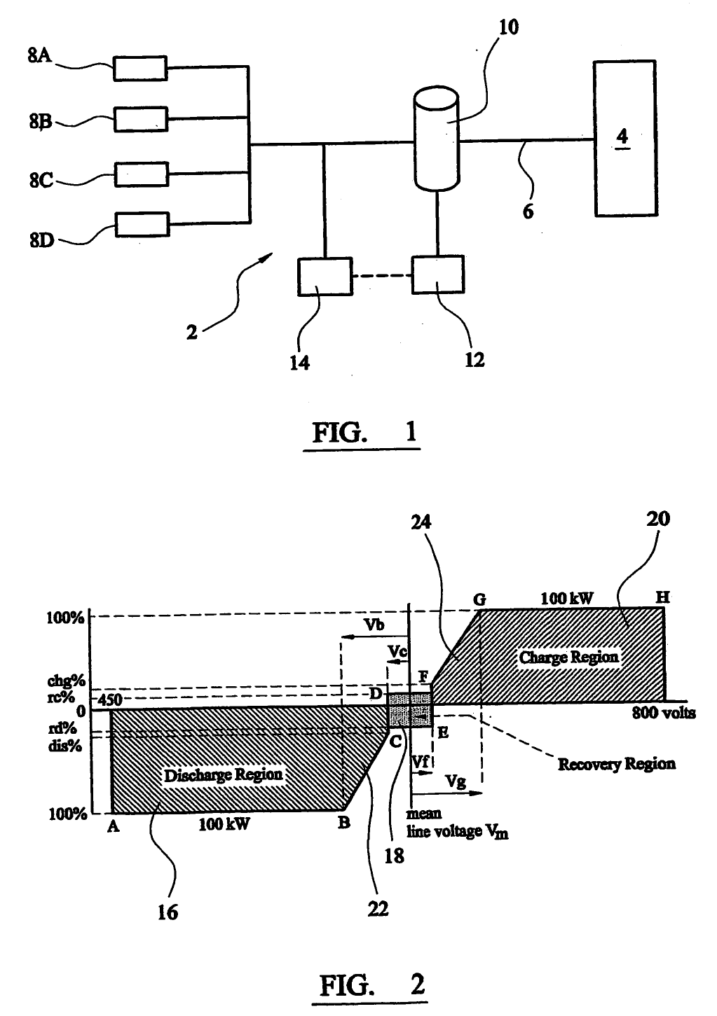

Referring to FIG. 2 of the drawings that follow, the mean line voltage Vₘ is a time averaged line voltage over a pre-defined rolling time interval, such as a few tens of seconds to several minutes to accommodate medium-term changes in the mean line voltage, for example during peak/off-peak times.

In FIG. 2, the X axis represents the line voltage in Vlts and the Y axis represents the power profile (rate of charge/discharge of the flywheel 10.

In FIG. 2 there is a discharge region 16, a recovery region 18 and a charge region 20. In this example the minimum line voltage is 450V and the maximum line voltage is 800V. In the discharge region 16, there is a reduced discharge region 22. In the charge region 20, there is a reduced charge region 24.

Apart from the maximum and minimum line voltages, the voltage settings are offset referenced to the mean line voltage Vₘ. The discharge region 16 is a region from Vₘ−V_{c} to the voltage minimum. The recovery region 18 is from Vₘ−V_{c} to Vₘ to V_{f}. The charge region 20 is from Vₘ+V_{f} to the maximum voltage. The reduced discharge region 22 is from Vₘ−V_{c} to Vₘ−V_{b}. The reduced charge region 24 is from Vₘ+V_{f} to Vₘ+V_{g}. V_{f} need not be the same as V_{c}. V_{b} need not be the same as V_{g}.

It will be appreciated that the present invention can be applicable to a plurality of flywheels 10, or other energy storage devices operating in series or parallel.

With reference to FIGS. 2-7 of the drawings that follow, operation of the present invention will now be described in more detail.

Line voltage monitor 14 monitors the line voltage of line 6 and communicates this to flywheel controller 12. Based on the voltage information, the flywheel controller 12 controls the flywheel as follows.

If the line voltage is in the discharge region 16, then if the flywheel 10 is above its base speed (500 Hz), the flywheel 10 discharges power to the line 6 at a reduced discharge rate (mode B) in the reduced discharge region 22 and at the full discharge rate (mode A) in the rest of discharge region 16, until the flywheel 10 reaches the base speed (500 Hz) at which point the flywheel drive is inhibited and the flywheel 10 enters the coast mode (D). The flywheel 10 remains coasting until the line voltage leaves the discharge region 16.

This profile is represented in FIG. 3 of the drawings that follow in which, as in FIGS. 4-7, the X axis represents time and the Y axis represents the flywheel speed.

Conversely, when the line voltage is detected by line voltage monitor 14 to have entered the charge region 20, then assuming the flywheel 10 is below the top speed, the flywheel 10 starts to charge at a reduced charge rate (mode F) in reduced charge region 24 and at full charge rate (mode G) in the rest of the charge region 20. As the flywheel 10 is charged, its speed increases, in time increasing to full power, ie top speed. Once the flywheel reaches its full power rating, top speed, the flywheel drive is inhibited and the flywheel coasts in an idlewindow 26 (FIG. 4), 5 Hz below top speed. Outside the idlewindow, the flywheel drive is re-enabled. The flywheel speed will continue to follow the coast/charge pattern until the line voltage leaves the charge region 20. This is shown in FIG. 4 of the drawings that follow.

In the case in which the line voltage is in the recovery region 18, whether above or below the mean line voltage Vₘ, the flywheel controller controls the flywheel 10 to drive the flywheel speed to the mid position, an idlespeed of 570 Hz.

The way in which the flywheel 10 is driven to the mid position, idlespeed differs depending upon from which direction the flywheel 10 is approaching idlespeed.

If the flywheel speed is above idlespeed plus an Idlewindow (5 Hz), the flywheel discharges at RD % (mode B) until the speed reaches idlespeed+idlewindow when the flywheel drive is inhibited, ie coasts (mode D). The flywheel 10 coasts until the speed reaches idlewindow (5 Hz) below idlespeed, when the drive is enabled. The flywheel then charges at RC % of full power (mode E). Once the flywheel 10 reaches idlespeed, the drive is inhibited once more (enters coast mode D), until the speed reaches idlespeed−idlewindow. This process then repeats until the line voltage leaves the recovery region 18.

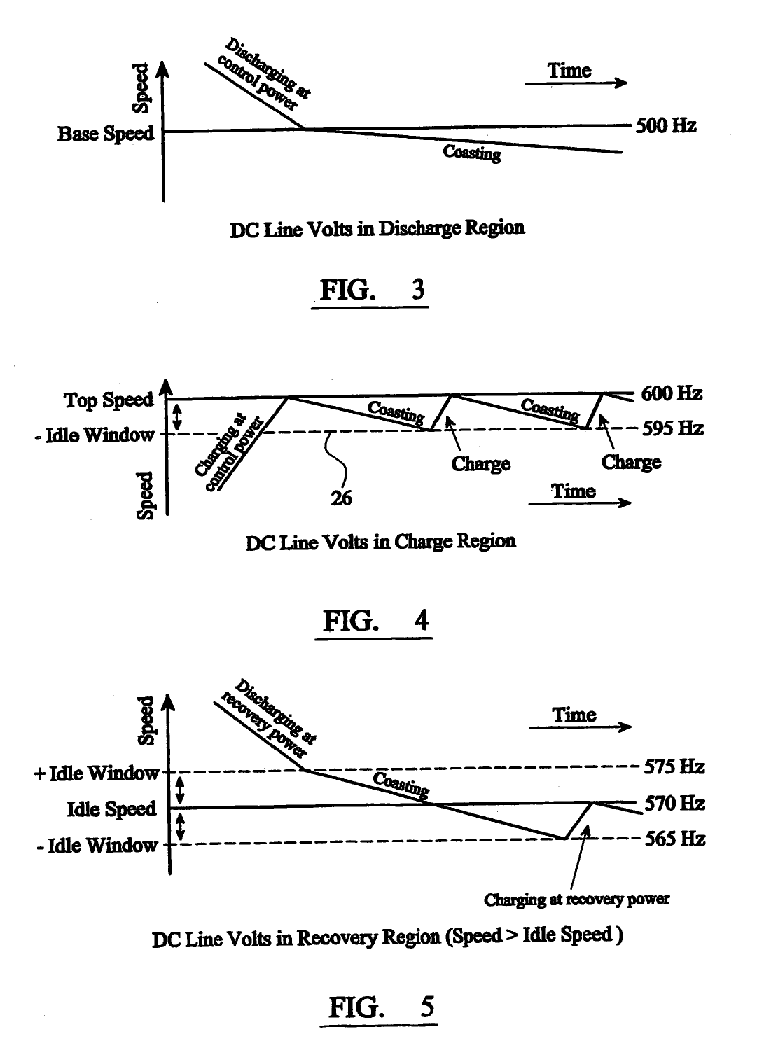

This operation is shown in FIG. 5 of the drawings that follow.

If the flywheel speed is below idlespeed−idlewindow (5 Hz) the flywheel charges at the RC % (mode E) until the speed reaches idlespeed, when the drive is inhibited (ie coasts−mode D). Typical recovery region charging may be 5-10%. The flywheel 10 coasts until idlewindow below idlespeed when the flywheel drive is enabled and the flywheel charges at the recovery level (mode E). This process repeats until the line voltage leaves the recovery region 18.

This operation is illustrated in FIG. 6 of the drawings that follow.

If the line voltage falls below extreme maxima and minima voltages, in the case of the preferred embodiment of the present invention 450 volts being the minima and. 800 volts being the maxima, the drive electronics is inhibited for the duration of the excursion.

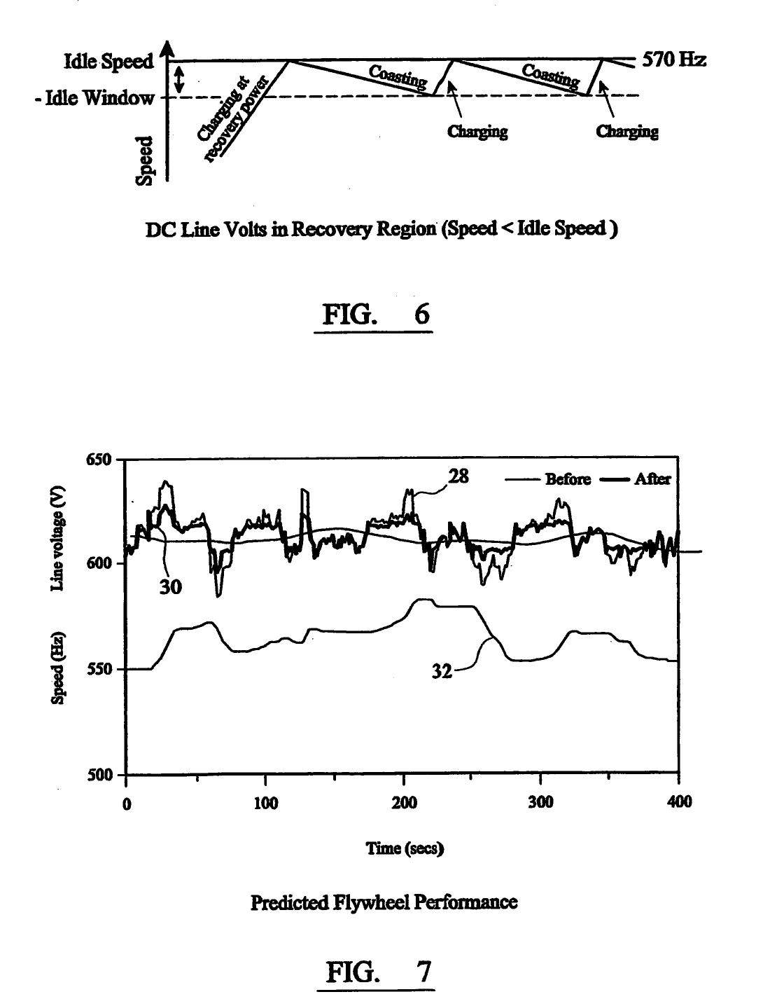

Referring to FIG. 7 of the drawings that follow, there is shown a graphical representation of line voltage (Y axis) in Volts of a power supply system without a system according to the present invention (line 28) and with a system according to the present invention, darker line 30. The speed in Hz of the corresponding flywheel is shown by line 32. The X axis represents time in seconds.

As can be seen from FIG. 7, the line voltage is substantially smoothed and the maxima and minima of the line voltages are dampened.

It will be appreciated that although the present invention is described in relation to flywheel energy storage devices, it can be applied to others such as capacitors and batteries.

The reader's attention is directed to all papers and documents which are filed concurrently with or previous to this specification in connection with this application and which are open to public inspection with this specification, and the contents of all such papers and is documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A control apparatus for a power supply system operable at a fluctuating line voltage, the system further comprising an energy storage device, and the control apparatus further comprising a line voltage monitor and an energy storage device controller, wherein the control apparatus is configured whereby the energy storage device is at least partly discharged if the line voltage falls below a first predetermined voltage and the energy storage device is at least partly charged if the line voltage exceeds a second predetermined voltage and in which the first predetermined voltage is substantially lower than the second predetermined voltage.

2. A control apparatus for a power supply system according to claim 1, in which in the voltage region between the first and second predetermined voltages, the energy storage device is driven to a predetermined charge setting between a maximum charge setting and a minimum charge setting.

3. A control apparatus for a power supply system according to claim 1, in which the first and second voltages are determined relative to a mean line voltage.

4. A control apparatus for a power supply system according to claim 3, in which the mean line voltage is determined by a time average over a predefined rolling time interval.

5. A control apparatus for a power supply system according to claim 1, in which an idle charge is defined with a positive idlewindow above the idlecharge and a negative idlewindow below the idlecharge, whereby in a region between the first predetermined voltage and the second predetermined voltage the energy storage device is neither charging nor discharging as the charge decreases until the charges reaches the negative idlewindow when it charges to a charge between the positive idlewindow and the negative idlewindow, and then neither charges nor discharges until the negative idlewindow is reached.

6. A control apparatus for a power supply system according to claim 1, in which a third voltage below the first predetermined voltage defines a reduced discharge region between the first predetermined voltage and the third voltage, in which the energy storage device is discharged at a lower rate than in a discharge region in which the line voltage is lower than the third voltage.

7. A control apparatus for a power supply system according to claim 1, in which a fourth voltage above the second predetermined voltage defines a reduced discharge region between the second predetermined voltage and the fourth voltage, in which the energy storage device is charged at a lower rate than in a charge region in which the line voltage is higher than the fourth voltage.

8. A control apparatus for a power supply system according to claim 1, in which an energy storage device maximum charge is defined and a maximum charge idlewindow is defined below and in relation thereto, and the apparatus is configured whereby if the line voltage is above the second predetermined voltage, upon the energy storage device reaching maximum charge it is neither charged nor discharged until the energy storage device charge falls to the maximum charge idlewindow at which stage the energy storage device is charged.

9. A control apparatus for a power supply system according to claim 1, in which an energy storage device minimum charge is defined and the apparatus is configured whereby upon the energy storage device reaching the energy storage device minimum charge the energy storage device is neither charged nor discharged until the line voltage rises above the first predetermined voltage.

10. A control apparatus for a power supply system according to claim 1, in which the energy storage device is a flywheel.

11. A power supply system comprising a control apparatus according to claim 1.

12. A power supply system according to claim 11, in which the power supply system is for a transport system.

13. A method of controlling a power supply system operating at a fluctuating line voltage, the system further comprising an energy storage device, and the control apparatus further comprising a line voltage monitor and an energy storage device controller, whereby the energy storage device is at least partly discharged if the line voltage falls below a first predetermined voltage and the energy storage device is at least partly charged if the line voltage exceeds a second predetermined voltage and in which the first predetermined voltage is substantially lower than the second predetermined voltage.

14. A method of controlling a power supply system according to claim 13, in which in the voltage region between the first and second predetermined voltages, the energy storage device is driven to a predetermined charge setting between a maximum charge setting and a minimum charge setting.

15. A method of controlling a power supply system according to claim 13, in which the first and second predetermined voltages are determined relative to a mean line voltage.

16. A method of controlling a power supply system according to claim 15, in which the mean line voltage is determined by a time average over a predefined rolling time interval.

17. A method of controlling a power supply system according to claim 13, in which an idlecharge is defined with a positive idlewindow above the idlecharge and a negative idlewindow below the idlecharge, whereby in a region between the first predetermined voltage and the second predetermined voltage the energy storage device is neither charging nor discharging as the charge decreases until the charge reaches the negative idlewindow when it charges to a charge between the positive idlewindow and the negative idlewindow, and then neither charges nor discharges until the negative idlewindow is reached.

18. A method of controlling a power supply system according to claim 13, in which a third voltage below the first predetermined voltage defines a reduced discharge region between the first predetermined voltage and the third voltage, in which the energy storage device is discharged at a lower rate than in a discharge region in which the line voltage is lower than the third voltage.

19. A method of controlling a power supply system according to claim 13, in which a fourth voltage above the second predetermined voltage defines a reduced discharge region between the second voltage and the fourth voltage, in which the energy storage device is charged at a lower rate than in a charge region in which the line voltage is higher than the fourth voltage.

20. A method of controlling a power supply system according to claim 13, in which an energy storage device maximum charge is defined and a maximum charge idlewindow is defined below and in relation thereto, and the apparatus is configured whereby if the line voltage is above the second predetermined voltage, upon the energy storage device reaching maximum charge it is neither charged nor discharged until the energy storage device charge falls to the maximum charge idlewindow at which stage the energy storage device is charged.

21. A method of controlling a power supply system according to claim 13, in which an energy storage device minimum charge is defined and the apparatus is configured whereby upon the energy storage device reaching the energy storage device minimum charge the energy storage device is neither charged nor discharged until the line voltage rises above the first predetermined voltage.

22. A method of controlling a power supply system according to claim 13, in which the energy storage device is a flywheel.
